(19) United States
(12) Patent Application Publication
(10) Pub. No.: US 2001/0050715 A1
(43) Pub. Date: Dec. 13, 2001

(54) Image photographing apparatus and method

(76) Inventor: Kenichi Sanpei, Chiba (JP)

Correspondence Address: William S. Frommer, Esq., c/o FROMMER LAWRENCE & HAUG LLP, 745 Fifth Avenue, New York, NY, 10151, US

(21) Appl. No.: 09/768,851

(22) Filed: Jan. 23, 2001

(30) Foreign Application Priority Data
Jan. 25, 2000 (JP) P2000-016114

(51) Int. Cl. H04N 3/14

(52) U.S. Cl. 348/312; 348/350; 348/333.11

(57) ABSTRACT

An image photographing apparatus for photographing a still image includes a scanning imaging device for generating image signals and a control unit for using the image signals generated by the imaging device to adjust the still image before photographing. The control unit defines a detection area on the imaging device, and reads only the image signals within the detection area out of the imaging device, so that the time required for the adjustment is reduced to attain more accurate adjustment.

### BACKGROUND OF THE INVENTION

1. Field of the Invention

The present invention generally relates to imaging systems for use in digital still cameras. More particularly, the present invention is directed to an image photographing apparatus, incorporating an imaging device having multiple pixels and a high resolution, in which the time required for adjustment such as automatic focus control with the use of the imaging device is reduced, and to an image photographing method.

2. Description of the Related Art

As known in the art, an image photographing apparatus incorporating an imaging device for producing image signals is implemented by, for example, an apparatus shown in FIG. 5. The apparatus includes an image capturing unit 14 having a lens system 11 and a diaphragm mechanism 12, constituting a focus control mechanism driven by a motor 10, and an imaging device 13 on which image light from a target object is projected. The imaging device 13 may be a charge coupled device (hereinafter abbreviated to CCD). A CCD is used to extract image signals by sequential scans on a plane based on, for example, drive pulse signals supplied thereto.

The image signals extracted by the imaging device 13 are passed to a sample-and-hold (hereinafter abbreviated to S/H) and automatic gain control (hereinafter abbreviated to AGC) circuit 15 where the image signals sampled for each pixel of the imaging device 13 are extracted and are subjected to gain control, before being received by a camera image processing unit 16. In the camera image processing unit 16, the received image signals are detected by a detector circuit 17, and the detected image signals are passed to a color control circuit 18 for performing adjustment, such as white balance control, on the signals.

The image signals output from the camera image processing unit 16, on which adjustment such as white balance control has been performed, are recorded on a recording medium 20 via a recording processing unit 19. The image signals output from the camera image processing unit 16, on which adjustment such as white balance control has been performed, are also received by a display control unit 21 for controlling the image signals for a display format etc. The image signals controlled by the display control unit 21 are then sent to an image display unit 22 such as a liquid crystal display (hereinafter abbreviated to LCD), and to an image signal output terminal 23.

The apparatus further includes a system control microcomputer 24. The microcomputer 24 controls the above-described circuits and the like in response to operational instructions supplied from the outside through an interfacing microcomputer 25. The microcomputer 24 contains various image information such as information on the image signals detected by the detector circuit 17. Based on such image information, adjustment such as automatic focus control, automatic photographic sensitivity control, or automatic white balance control is carried out.

Specifically, for example, the automatic focus control is based on levels of a high frequency component of the image signal detected by the detector circuit 17, with the use of focus control of the lens system 11 via the motor 10. The automatic photographic sensitivity control is based on luminance signal levels of the image signal detected by the detector circuit 17, with the use of control signals including an aperture control signal to the diaphragm mechanism 12, an image read-out control signal to the imaging device 13, and a gain control signal to the S/H and AGC circuit 15. The white balance control, which is performed in the color control circuit 18, is based on chrominance signal levels of the image signal detected by the detector circuit 17.

In this conventional apparatus, however, the information on the image signals detected by the detector circuit 17 is not obtained until a scan on a whole plane is executed by the imaging device 13. Typically, the above-described adjustment such as automatic focus control is performed with the amount of adjustment being slightly modified, and a considerable image scan time is thus required corresponding to the number of modifications of the adjustment amount until such adjustment is completed. Due to the considerable time required until the adjustment is completed, a target object may move during the adjustment before the target object is photographed, leading to a degradation in performance such that the adjustment may not be accurately performed.

Recently, digital cameras often use imaging devices having multiple pixels and a high resolution, and require prolonged image scan time, which results in a particularly serious problem in that a long time is required until the adjustment is completed. Furthermore, the above-described adjustment such as automatic focus control, automatic photographic sensitivity control, or automatic white balance control is often carried out while a shutter button (not shown) is half-pressed. Another problem arises in that in this situation, the length of time from the initiation to the completion of the adjustment is prolonged.

Meanwhile, information necessary for the above-described adjustment such as automatic focus control, automatic photographic sensitivity control, or automatic white balance control does not necessarily use the whole plane of the picture captured by the imaging device 13. Rather, it is necessary to read out signals only in, for example, a detection area indicated by a solid line at the center of a CCD effective pixel plane which is indicated by the outer frame in FIG. 6. Nevertheless, typical apparatuses ensure that the imaging device 13 is controlled so as to read out the signals in the whole plane, and a considerable image scan time is thus required to obtain information for single-time sampling.

### SUMMARY OF THE INVENTION

Accordingly, an object of the present invention is to provide an image photographing apparatus and method in which the time required for adjustment such as automatic focus control, automatic photographic sensitivity control, or automatic white balance control is reduced so that more accurate adjustment and more realistically photographed images may be achieved.

According to the present invention, for the adjustment by using an imaging device, only signals within a predetermined detection area on the imaging device are read out. Therefore, the time required for a single read-out operation of signals is reduced, thereby reducing the time required for the adjustment as a whole, so that more accurate adjustment and more realistically photographed images may be achieved.

In one aspect of the present invention, an image photographing apparatus for photographing a still image, includes a scanning imaging device for generating image signals and a control unit for using the image signals generated by the imaging device to adjust the still image before photographing. The control unit defines a detection area on the imaging device, and reads only the image signals within the detection area out of the imaging device. The read image signals are then used to adjust the still image before photographing. Therefore, the time required for a single read-out operation of the signals is reduced, thereby reducing the time required for the adjustment as a whole, so that more accurate adjustment and more realistically photographed image may be achieved.

The control unit may also control the imaging device when the still image is being photographed, so that successful controlling operations may always be achieved.

The control unit may determine a start position of the detection area and the amount of image signals to be read out within the detection area, and only the image signals within the detection area are read out of the imaging device accordingly. Therefore, a simple structure is required to provide successful control operations.

The control unit may allow a high-speed scan in a region before the start position of the detection area, a predetermined-speed scan in the detection area, and only the determined amount of the image signals to be read out. Therefore, a simple structure is required to provide successful control operations.

Advantageously, based on the read image signals, at least one of automatic focus control, automatic photographic sensitivity control, and automatic white balance control is performed.

In another aspect of the present invention, an image photographing method for photographing a still image includes providing a scanning imaging device for generating image signals. When the image signals generated by the imaging device are used to adjust the still image before photographing, the method further includes allowing a control unit to define a detection area on the imaging device and allowing the control unit to read only the image signals within the detection area out of the imaging device. The read image signals are then used to adjust the still image before photographing. Therefore, the time required for a single read-out operation of the signals is reduced, thereby reducing the time required for the adjustment as a whole, so that more accurate adjustment and more realistically photographed image may be achieved.

### BRIEF DESCRIPTION OF THE DRAWINGS

FIG. 1 is a block diagram of an image photographing apparatus according to an embodiment of the present invention;

FIG. 2 is a block diagram of a timing generator circuit in the image photographing apparatus shown in FIG. 1;

FIG. 3 is a flowchart describing the control of the image photographing apparatus;

FIG. 4 is an illustration of a CCD effective pixel plane embodying the present invention;

FIG. 5 is a block diagram of a conventional image photographing apparatus; and

FIG. 6 is an illustration of a CCD effective pixel plane employed in the conventional image photographing apparatus.

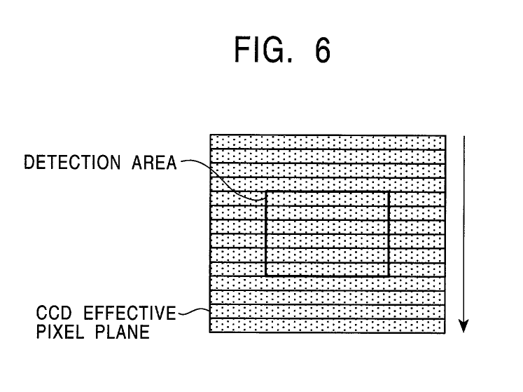

### DESCRIPTION OF THE PREFERRED EMBODIMENT

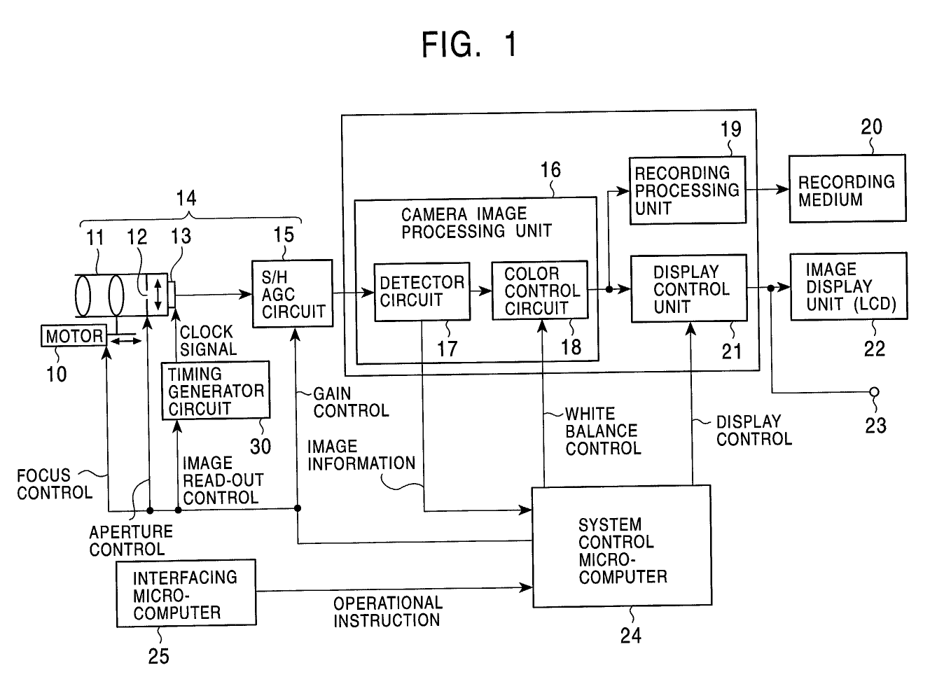

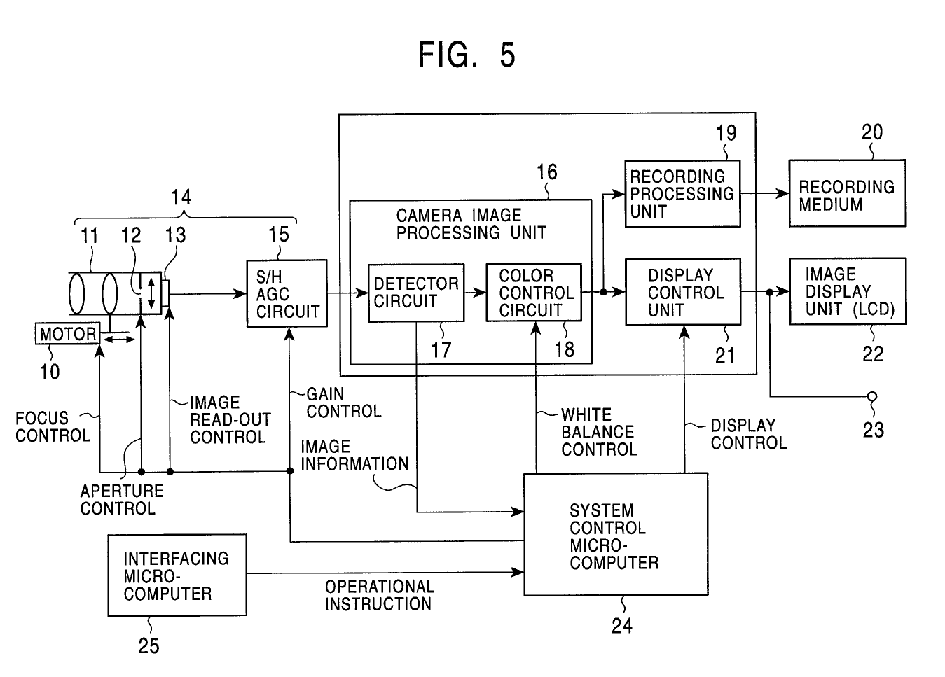

FIG. 1 is a block diagram of a digital still camera embodying an image photographing apparatus according to an embodiment of the present invention, wherein the same reference numerals are assigned to components corresponding to those shown in FIG. 5, and thus a detailed description thereof is omitted.

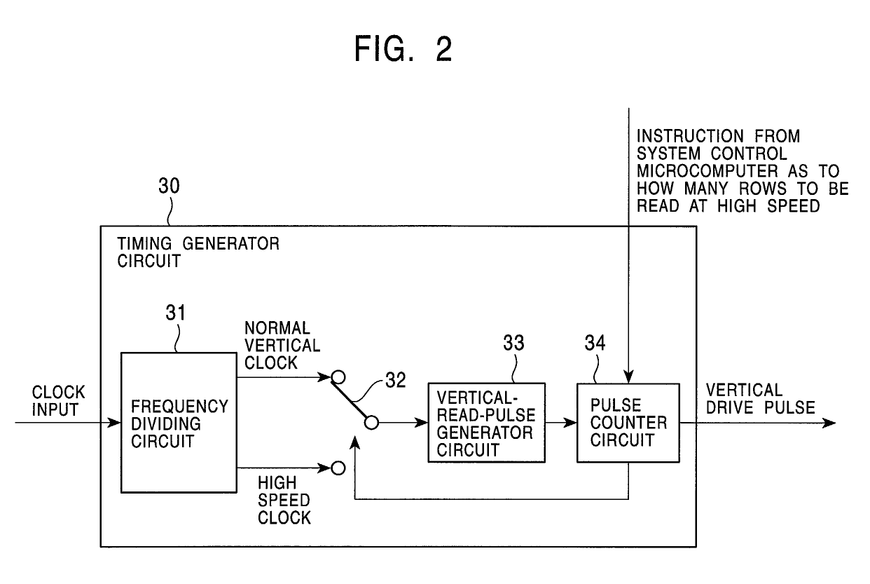

The image photographing apparatus shown in FIG. 1 includes an image capturing unit 14 having a lens system 11 and a diaphragm mechanism 12, constituting a focus control mechanism driven by a motor 10, and an imaging device 13 on which image light from a target object is projected. The imaging device 13 may be a CCD, as previously described. A CCD is used to extract image signals by sequential scans on a plane based on, for example, drive pulse signals generated by a timing generator circuit 30. The timing generator circuit 30, which is of the type employed in a typical apparatus, is illustrated in FIG. 2.

Referring to FIG. 2, a clock input having a certain frequency is received by a frequency dividing circuit 31 to generate both a normal vertical clock for reading out an image and a high speed clock having a higher frequency. The normal vertical clock and the high speed clock are selectively switched by a switching unit 32, and either is then passed to a vertical-read-pulse generator circuit 33. The pulse signals generated by the vertical-read-pulse generator circuit 33 are extracted through a pulse counter circuit 34. The extracted pulse signals are passed to the imaging device (CCD) 13 as vertical drive pulse signals.

Furthermore, the pulse counter circuit 34 receives an instruction from the control microcomputer 24, for example, as to how many rows are to be read at high speed, and sets a value in response to the instruction. When a counted value reaches the set value, output signals are generated to control the switching operation of the switching unit 32. Accordingly, for example, the switching unit 32 is controlled so that the high speed clock is first selected by the switching unit 32, and then, when the counted value of the pulse counter circuit 34 reaches the set value, the normal vertical clock is selected.

Referring again to FIG. 1, the image signals extracted by the imaging device 13 are passed to an S/H and AGC circuit 15 where the image signals sampled for each pixel of the imaging device 13 are extracted and are subjected to gain control, before being received by a camera image processing unit 16. In the camera image processing unit 16, the received image signals are detected by a detector circuit 17, and the detected image signals are passed to a color control circuit 18 for performing adjustment, such as white balance control, on the signals.

The image signals output from the camera image processing unit 16, on which adjustment such as white balance control has been performed, are recorded on a recording medium 20 via a recording processing unit 19. The image signals output from the camera image processing unit 16, on which adjustment such as white balance control has been performed, are also received by a display control unit 21 for controlling the image signals for a display format etc. The image signals controlled by the display control unit 21 are then sent to an image display unit 22 such as an LCD, and to an image signal output terminal 23.

The image photographing apparatus further includes a system control microcomputer 24. The microcomputer 24 controls the above-described circuits and the like in response to operational instructions supplied from the outside through an interfacing microcomputer 25. The microcomputer 24 contains various image information such as information on the image signals detected by the detector circuit 17. Based on such image information, adjustment such as automatic focus control, automatic photographic sensitivity control, or automatic white balance control is carried out.

Specifically, for example, the automatic focus control is based on levels of a high frequency component of the image signal detected by the detector circuit 17, with the use of focus control of the lens system 11 via the motor 10. The automatic photographic sensitivity control is based on luminance signal levels of the image signal detected by the detector circuit 17, with the use of control signals including an aperture control signal to the diaphragm mechanism 12, an image read-out control signal to the imaging device 13, and a gain control signal to the S/H and AGC circuit 15. The automatic white balance control, which is performed in the color control circuit 18, is based on chrominance signal levels of the image signal detected by the detector circuit 17.

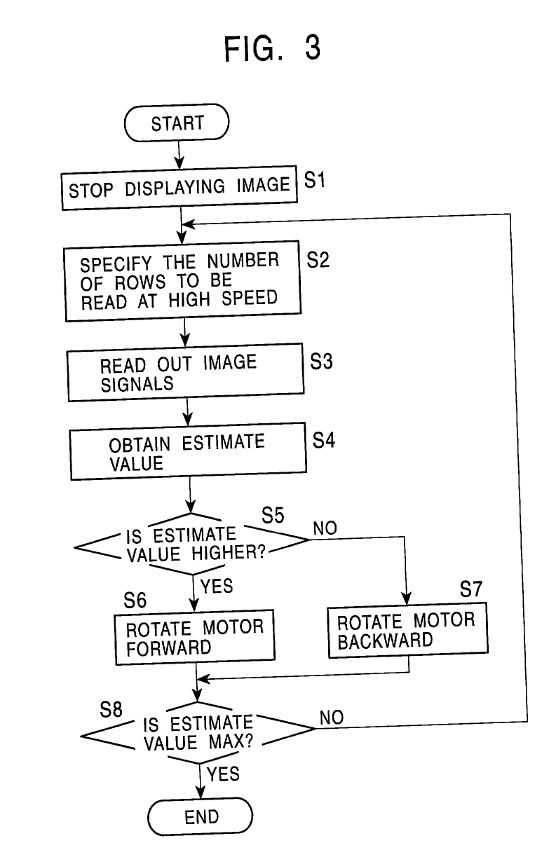

The system control microcomputer 24 performs control as described in a flowchart of FIG. 3. The control starts while a shutter button (not shown) is half-pressed. At Step S1, the control stops displaying the image on the display control unit 21. The control proceeds to Step S2 wherein the number of rows to be read at high speed is specified, as previously described. According to the specification, an instruction to read out image signals is issued at Step S3. Accordingly, the image signals are read out from the imaging device (CCD) 13.

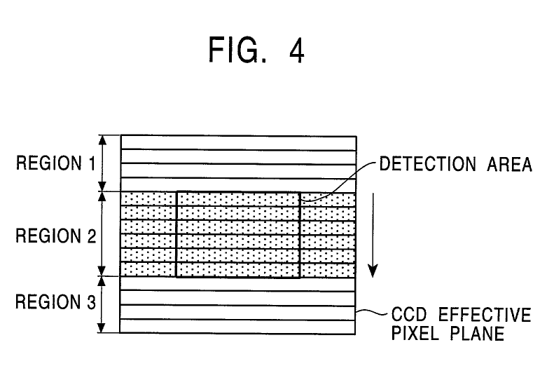

FIG. 4 illustrates a CCD effective pixel plane as indicated by the outer frame. Only the horizontal lines corresponding to a portion within a detection area indicated by a solid line at the center of the CCD effective pixel plane are read out from the imaging device 13. Therefore, at Step S2, the number of rows corresponding to a region 1 shown in FIG. 4 is specified. In response, the signals in region 1 of the imaging device 13 are read out at high speed. The signals in a region 2 that follows are read out at normal speed. By setting this control period in correspondence with a read-out period of the region 2, only the horizontal lines corresponding to a portion within the detection area are read out.

Referring back to FIG. 3, at Step S4, an estimate value of the image signal detected by the detector circuit 17 is captured. In the case where automatic focus control is to be performed, for example, a level of a high frequency component of the image signal is read as the estimate value. At Step S5, the control determines whether the read estimate value is higher than the previous estimate value. If the read estimate is higher, i.e., YES is obtained, the motor 10 is rotated forward at Step S6. Otherwise, i.e., if NO is obtained, the motor 10 is rotated backward at Step S7. Control is performed such that the read estimate value approximates a maximum value (MAX).

At Step S8, the control determines whether the resultant estimate value is maximum (MAX). If the estimate value is not maximum, i.e., NO is obtained, the control is returned to Step S2. Otherwise, i.e., if YES is obtained, the control terminates. In this manner, the focus control of the lens system 11 may be performed via the motor 10, and the automatic focus control may be performed by obtaining the maximum level of the high frequency component of the image signal. Similarly, the automatic photographic sensitivity control is based on luminance signal levels, and the automatic white balance control is based on chrominance signal levels.

Consequently, adjustment such as automatic focus control, automatic photographic sensitivity control, or automatic white balance control is carried out. By allowing only horizontal lines corresponding to a portion within the detection area indicated by the solid line in FIG. 4 to be read out of the imaging device 13, and by setting the control period in correspondence with a read-out period of the detection area, the detection can be repeated at the read-out period of the detection area. For example, if the horizontal lines corresponding to a portion within the detection area occupy one third the CCD effective pixel plane, the detection will require one third a conventional detection time.

According to the illustrated embodiment, for the adjustment with the use of an imaging device, only signals within a predetermined detection area on the imaging device are read out. Therefore, the time required for a single read-out operation of signals is reduced, thereby reducing the time required for the adjustment as a whole, so that more accurate adjustment and more realistically photographed images may be achieved.

The present invention is not limited to the illustrated embodiment, and a variety of modifications and variations may be employed without departing from the spirit of the invention.

What is claimed is:

1. An image photographing apparatus for photographing a still image, comprising:
a scanning imaging device for generating image signals; and
control means for using the image signals generated by said imaging device to adjust the still image before photographing, said control means defining a detection area on said imaging device and reading only the image signals within the detection area out of said imaging device, the read image signals being used to adjust the still image before photographing.

2. An image photographing apparatus according to claim 1, wherein said control means also controls said imaging device when the still image is being photographed.

3. An image photographing apparatus according to claim 1, wherein said control means determines a start position of the detection area and the amount of image signals to be read out within the detection area, and, accordingly, only the image signals within the detection area are read out of said imaging device.

4. An image photographing apparatus according to claim 3, wherein said control means allows a high-speed scan in a region before the start position of the detection area, allows a predetermined-speed scan in the detection area, and allows only the determined amount of image signals to be read out.

5. An image photographing apparatus according to claim 1, wherein, based on the read image signals, at least one of automatic focus control, automatic photographic sensitivity control, and automatic white balance control is performed.

6. An image photographing method for photographing a still image by a scanning imaging device for generating image signals, comprising the steps of:
when the image signals generated by the imaging device are used to adjust the still image before photographing:
defining, by control means, a detection area on the imaging device; and
reading, by the control means, only the image signals within the detection area out of the imaging device; and
adjusting, by using the read image signals, the still image before photographing.

7. An image photographing method according to claim 6, wherein the control means also controls the imaging device when the still image is being photographed.

8. An image photographing method according to claim 6, wherein the reading step includes the step of allowing the control means to determine a start position of the detection area and the amount of image signals to be read out within the detection area, so that only the image signals within the detection area are read out of the imaging device accordingly.

9. An image photographing method according to claim 8, further comprising the step of:
allowing the control means to perform a high-speed scan in a region before the start position of the detection area, to perform a predetermined-speed scan in the detection area, and to read out only the determined amount of image signals.

10. An image photographing method according to claim 6, wherein, based on the read image signals, at least one of automatic focus control, automatic photographic sensitivity control, and automatic white balance control is performed.
